(19) United States
(12) Patent Application Publication
(10) Pub. No.: US 2009/0254956 A1
(43) Pub. Date: Oct. 8, 2009

(54) COMMUNICATION SIGNAL CHARACTERISTIC MEASUREMENT SYSTEM

(75) Inventors: Boris Smychkovich, Alpharetta, GA (US); Jim Harris, Loganville, GA (US)

Correspondence Address: LAW OFFICES OF MIKIO ISHIMARU, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 12/098,260

(22) Filed: Apr. 4, 2008

(51) Int. Cl. H04N 7/173

(52) U.S. Cl. 725/105

(57) ABSTRACT

A communication signal characteristic measurement system comprising: detecting a quiet line including: storing a specific characteristic data, detecting a vertical synchronization pulse in the specific characteristic data, and applying an eight line delay in the specific characteristic data; and displaying a data set showing the quiet line relative to the vertical synchronization pulse.

### TECHNICAL FIELD

The present invention relates generally to quality measurement of communication signals, and more particularly to a system for measuring characteristics of a communication signal modulated by a video signal.

### BACKGROUND ART

With the popularity of high definition television skyrocketing, the delivery systems of the high definition communication signals are adding new stresses to the communication infrastructure. Many of the existing cable systems will be able to deliver acceptable signal quality for the first generation of high definition products, but may require a dramatic upgrade by the second or third generation. In order to facilitate the maintenance and continued support of the existing infrastructure, deficiencies in the system must be analyzed, compensated for, or corrected.

Cable Television (CATV) systems that distribute communication signals used by high definition televisions utilize power amplifiers with high linearity specifications in order to minimize inter-modulation distortion. The major parameters in the CATV specification, to determine a passing or failing system, are the linearity characteristics in terms of the composite second order (CSO) distortion frequencies and the composite third beat (CTB) frequency of the delivery channel.

It is desirable to measure the quality of a signal, such as communication signal modulated with a composite video signal in a CATV system, in the presence of modulation, without the need for a synchronizing device. This has long been an issue for field support of CATV systems. Due to the complexity of the communication signal modulated with a composite video signal, several pieces of test equipment might be required to complete the analysis. The variability in the equipment and requirements to keep tools calibrated with one another makes accurate measurements very difficult.

In order to assess the characteristics of the distribution network, it is required to collect segments of data that represent at least a full screen of data and then examine the distortion that has modified the original data. Several methods have been proposed, but they also require additional equipment.

The goal of improvements in the analysis of the CATV system is to extend the useful life of the infrastructure. By extracting every distortion causing device from the system, the possibility exists that the CATV system could meet the requirements of the second generation of high definition television and thus saving billions of dollars of investments in the existing infrastructure.

Thus, a need still remains for communication signal characteristic measurement system. In view of the increasing demand for CATV supported high definition television, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a communication signal characteristic measurement system comprising: detecting a quiet line including: storing a specific characteristic data, detecting a vertical synchronization pulse in the specific characteristic data, and applying an eight line delay in the specific characteristic data; and displaying a data set showing the quiet line relative to the vertical synchronization pulse.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a functional block diagram of a communication signal characteristic measurement system in an embodiment of the present invention;

FIG. 2 is a flow chart of an initialization sequence of the communication signal characteristic measurement system, of FIG. 1;

FIG. 3 is a flow chart of a data capture process of the communication signal characteristic measurement system of FIG. 1;

FIG. 4 is a screen capture of data traced by the communication signal characteristic measurement system;

FIG. 5 is a screen capture of a magnified view of the data traced by the communication signal characteristic measurement system;

FIG. 6 is a diagram of a channel tester having the communication signal characteristic measurement system in an embodiment of the present invention; and

FIG. 7 is a flow chart of a communication signal characteristic measurement system for facilitating the communication signal characteristic measurement system, in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

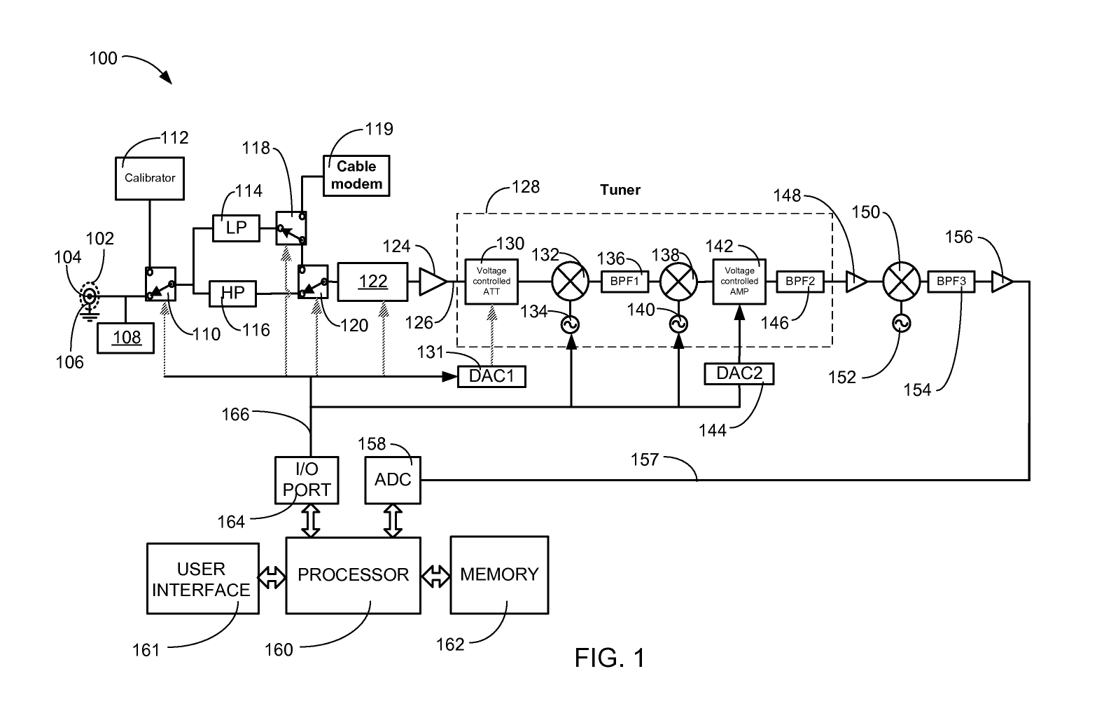

Referring now to FIG. 1, therein is shown a functional block diagram of a communication signal characteristic measurement system 100 in an embodiment of the present invention. The functional block diagram of the communication signal characteristic measurement system 100 depicts a CATV input 102, having a signal input 104 and a ground shield 106, connected to a voltage limiter 108 and a first switch 110. The first switch 110 may be used to select the CATV input 102 or a calibrator circuit 112, such as a generator of a known frequency and amplitude signal used for initializing the communication signal characteristic measurement system 100.

The first switch 110 may also be coupled to a low pass filter 114 and a high pass filter 116. The low pass filter 114 may be provided for analyzing an upstream frequency range in the data over cable system interface specification. The current frequency range may be between 5 Mega-hertz and 42 Mega-hertz. The output of the low pass filter 114 may be coupled to a second switch 118.

The second switch 118 may control the selection of the low pass filter 114 into the third switch 120. The second switch 118 may also select a cable modem input 119 in order to send the cable modem data to the third switch 120. The combination of the second switch 118 and the third switch 120 may select from the downstream data sourced from the high pass filter 116, the upstream data sourced from the low pass filter 114, or the cable modem data sourced from the cable modem input 119.

The high pass filter 116 may be provided for analyzing a downstream frequency range. The current frequency range of the data over cable system interface specification may be between 54 Mega-hertz and 1000 Mega-hertz. The output of the high pass filter 116 may be coupled to a third switch 120. The combination of the second switch 118 and the third switch 120 may form a diplexer which may allow either the output of the low pass filter 114 or the high pass filter 116 to be gated into a programmable attenuator 122. The programmable attenuator 122 may be set-up during a calibration process by selecting the calibrator circuit 112 with the first switch 110 and either the low pass filter 114 or the high pass filter 116 by the combination of the second switch 118 and the third switch 120. The output of the programmable attenuator 122 may be coupled to a linear amplifier 124 that conditions a composite video signal 126 for a tuner 128.

The tuner 128 may have a voltage controlled attenuator 130 that receives the composite video signal 126 and further conditions it based on the input from a first digital to analog convertor 131. The output of the voltage controlled attenuator 130 may be coupled to a first mixer 132. The first mixer 132 may also receive an input from a first programmable local oscillator 134. The output of the first mixer 132 may be coupled to a first band pass filter 136.

A second mixer 138 receives the output of the first band pass filter 136 and a frequency from a second programmable local oscillator 140. The combined signal becomes an input to a voltage controlled amplifier 142 which also receives input from a second digital to analog convertor 144. The output of the voltage controlled amplifier 142 enters a second band pass filter 146 which acts as the final output stage of the tuner 128. The tuner 128 is designed for quick transition between the frequencies associated with a channel under test.

The output of the second band pass filter 146 is coupled to a driver amplifier 148, which buffers the composite signal, and supplies an input to a third mixer 150. The third mixer 150 also receives input from a free-running local oscillator 152. The free-running local oscillator 152 may provide a fixed frequency output to the third mixer 150. A third band pass filter 154 may condition the output of the third mixer 150 for input to a logarithmic amplifier 156. The combination of the driver amplifier 148, the third mixer 150, the free-running oscillator 152, the third band pass filter 154, and the logarithmic amplifier 156 provide a means for rapid switching of the frequencies provided by the tuner 128. The switching time between frequency changes may be in the range of 10 μSec to 60 μSec.

The output of the logarithmic amplifier 156 represents a specific characteristic data 157 being analyzed by the communication signal characteristic measurement system 100. An analog to digital convertor 158 receives the analog output from the logarithmic amplifier 156 and converts the data for presentation to a processor 160, such as a digital signal processor (DSP), bit slice processor, or processor core. A user interface 161 may provide the processor 160 with the parameters needed for a trace of the specific characteristic data 157. The processor 160 may store the digitized representation of the specific characteristic data 157 in a memory 162 coupled to the processor. In some implementations, the memory 162 may be internal to the processor 160.

The processor 160 may also interface with an input output port expander 164, such as a field programmable gate array (FPGA), an application specific integrated circuit (ASIC), or a gate array. The input output port expander 164 allows the processor 160 to control the first switch 110, the second switch 118, the third switch 120, the programmable attenuator 122, the first digital to analog convertor 131, the second digital to analog convertor 144, the first programmable local oscillator 134, and the second programmable local oscillator 140 through a control and data bus 166.

It has been discovered that the design of the communication signal characteristic measurement system 100 allows the capture of at least two sequential frames of the specific characteristic data 157 from the composite video stream that is connected through the CATV input 102. The processor 160 may analyze the specific characteristic data 157 stored in the memory 162 to determine at least a quiet even line or a quiet odd line.

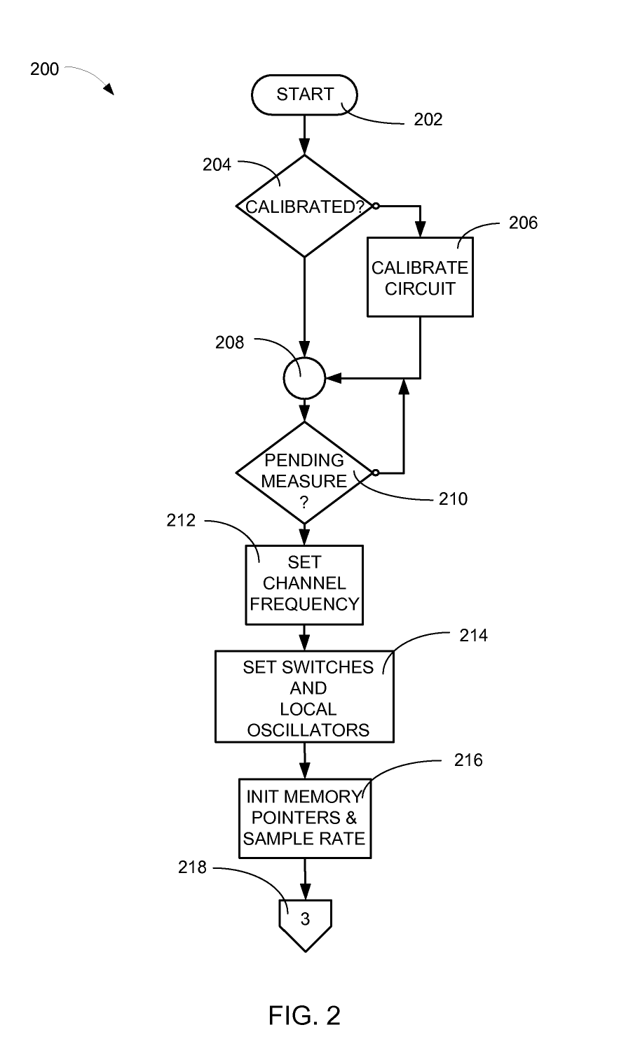

Referring now to FIG. 2, therein is shown a flow chart of an initialization sequence 200 of the communication signal characteristic measurement system 100, of FIG. 1. The flow chart of the initialization sequence 200 depicts a program start 202 leading to a calibrated check 204. The processor 160 of FIG. 1 executes the calibrated check 204 by examining an internal status register (not shown). If the communication signal characteristic measurement system 100 has not been calibrated, the program follows a bubbled output of the calibrated check 204 and enters a calibrate circuit block 206.

The calibrate circuit block 206 may include setting the first switch 110 of FIG. 1 to the calibrator circuit 112 of FIG. 1. The calibrator circuit 112 may provide a signal of known frequency and amplitude that will enable the processor 160 to adjust the programmable attenuator 122, of FIG. 1, the first digital to analog convertor 131, of FIG. 1, the first programmable local oscillator 134, of FIG. 1, the second programmable local oscillator 140, of FIG. 1, and the second digital to analog convertor 144, of FIG. 1, in order to detect an expected value on the specific characteristic data 157, of FIG. 1, as viewed through the analog to digital convertor 158, of FIG. 1. The processor 160 may direct the signal from the calibrator circuit 112 through the low pass filter 114, of FIG. 1, or the high pass filter 116, of FIG. 1. By completing this process, the processor 160 may create a table of values to set-up for each of the functions that it can manipulate.

When the process is complete, the flow moves to a re-entry point 208. The program will proceed to a pending measure check 210. The pending measure check 210 identifies whether a request for a trace has been logged through the user interface 161, of FIG. 1. The processor 160 may extract parameters from the user interface 161 in order to complete the trace. If the pending measure check 210 does not find a trace to be performed, the flow returns to the re-entry point 208 and loops back into the pending measure check 2 10.

When the pending measure check 210 detects a trace requested through the user interface 161, the processor 160 may read the channel frequency, sample rate, and frame count through the user interface 161. The program flow moves to a set channel frequency block 212. The processor 160 may tune the circuits to a visual carrier frequency of a channel under test.

The flow moves to a set switches block 214. The processor 160 may ready the path by setting the first switch 110, of FIG. 1, the second switch 118, and the third switch 120 to their appropriate positions to support the trace. Upon completing the set-up of the first switch 110, of FIG. 1, the second switch 118, and the third switch 120, the processor may initialize the first programmable local oscillator 134, of FIG. 1, and the second programmable local oscillator 140, of FIG. 1. At this point in the program, the processor 160 may also set-up the first digital to analog convertor 131, of FIG. 1, and the second digital to analog convertor 144, of FIG. 1

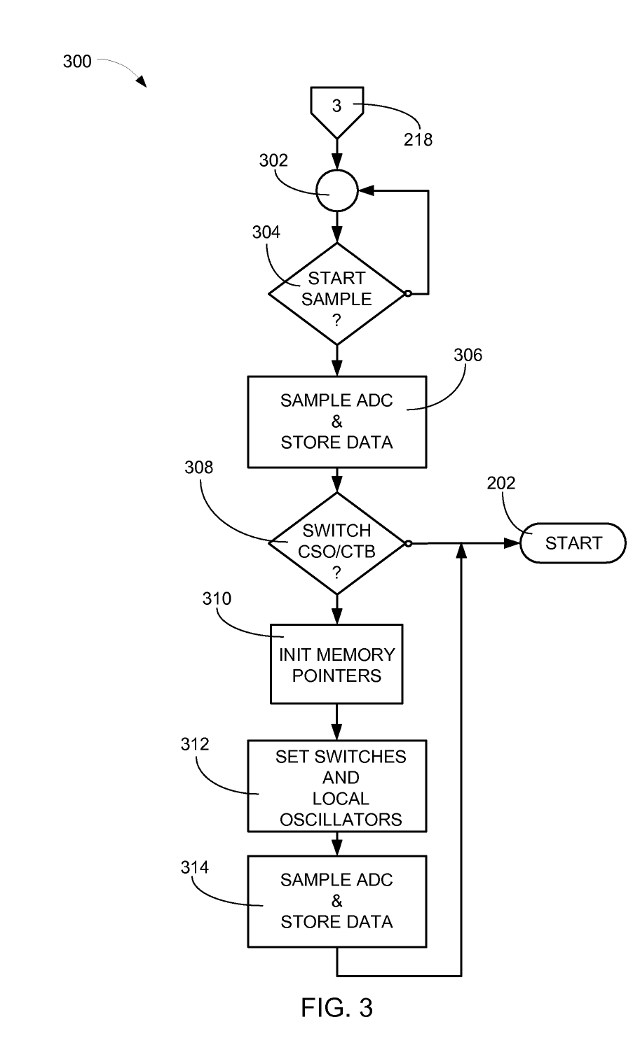

The program then moves to a set memory pointers block 216. The processor 160 acquires the necessary information from the user interface 161 and initializes its internal memory transfer pointers (not shown) to store the appropriate amount of data in the memory 162, of FIG. 1. The processor 160 may also set-up an interval timer (not shown) to facilitate the acquisition of the data to move to the memory 162. The flow then moves to a linkage point 218 and proceeds to the flow chart of FIG. 3.

Referring now to FIG. 3, therein is shown a flow chart of a data capture process 300 of the communication signal characteristic measurement system 100, of FIG. 1. The flow chart of the data capture process 300 depicts the linkage point 218 leading to a re-entry point 302. The program proceeds directly to a start sample block 304. If the trigger point for the trace has not been detected, the program returns to the re-entry point 302. If the trigger conditions have been met, the flow moves to a sample and store block 306.

The sample and store block 306 may read the digital representation of the specific characteristic data 157, of FIG. 1, through the analog to digital convertor 158, of FIG. 1. The data is read from the analog to digital convertor 158 and stored in the memory 162, of FIG. 1 in successive operations of the processor 160, of FIG. 1. The processor 160 continues to read and store the data until a data set is completely captured. The flow then moves to a switch CSO/CTB block 308.

The switch CSO/CTB block 308 may detect that a rapid transition to a new trace type is required. If no rapid transition is required, the program returns to the program start 202. If a rapid switch to new conditions for a trace is necessary, the program moves to an initialize memory pointers block 3 10.

In the initialize memory pointers block 310, the processor 160 may acquire new trace parameters from the user interface 161, of FIG. 1. The processor 160 may set-up a new start location in the memory 162 and a new data storage length. In certain embodiments of the present invention, an alternate hardware register may be available that will allow the processor to set-up the new pointers for the memory 162 prior to the first trace being complete. When the initial trace is done, the hardware register may be immediately available to address the next location in the memory 162. When the processor 160 has completed the set-up of the memory 162, the program moves to a set switches block 312.

The set switches block 312 may require the processor 160 to re-orient the disposition of the second switch 118, of FIG. 1, or the third switch 120, of FIG. 1. The processor 160 may also make changes to the first programmable local oscillator 134, of FIG. 1, and the second programmable local oscillator 140, of FIG. 1. At this point in the program, the processor 160 may also set-up the first digital to analog convertor 131, of FIG. 1, and the second digital to analog convertor 144, of FIG. 1.

In certain implementations of the present invention, an alternate register set may be available in the input output port expander 164, of FIG. 1. This alternate register set may allow the rapid transition to a new set of values for all of the programmable components. Such a transition might be performed in a range of 100 ηSec to 300 ηSec. At the completion of the set-up, the program moves to a sample and store block 314.

The sample and store block 314 may read the digital representation of the specific characteristic data 157, of FIG. 1, through the analog to digital convertor 158, of FIG. 1. The data is read from the analog to digital convertor 158 and stored in the memory 162, of FIG. 1 in successive operations of the processor 160, of FIG. 1. The processor 160 continues to read and store the data until a data set is completely captured. At the end of the operation, the flow moves to the program start 202 and awaits the next operation.

The flow that was described in FIG. 2 and FIG. 3 is by way of an example only. The actual operation of the processor 160 in its interaction with other hardware components may be different.

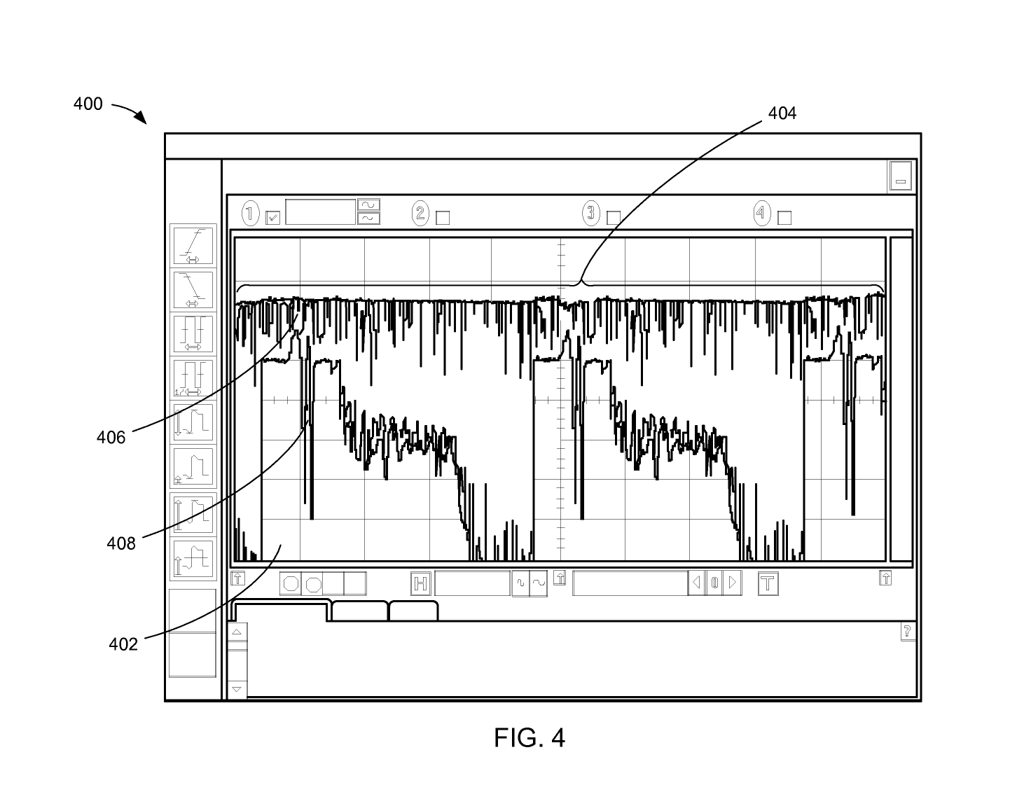

Referring now to FIG. 4, therein is shown a screen capture 400 of data traced by the communication signal characteristic measurement system 100. The screen capture 400 depicts a display screen 402, showing a trace of time versus voltage representing the power spectrum of a channel under test. The data stored in the memory 162, of FIG. 1, may be displayed on the display screen 402 by way of the user interface 161, of FIG. 1.

Once the data set for the visual carrier frequency is processed as an initial data set 404, such as two frames of the specific characteristic data, additional data sets at any other frequency can be analyzed. Specifically, the first plurality of samples is examined to identify the sample with the maximum value. The maximum value sample represents a power level of the communication signal at the visual carrier frequency in the channel under test. The level of the visual carrier frequency can be determined from the maximum value sample because the maximum value sample occurs at a vertical synchronization pulse (Vsync) 406, which is when there is no modulation of the communication signal. Thus, once the maximum value sample is identified in the first plurality of samples, the level of the visual carrier frequency in the channel is determined through some calibration techniques. Calibration is performed by applying the composite video signal of known power levels to the input resulting in system output responses in a range corresponding to typically possible measurement conditions. Linear approximation can then be used for responses falling between the calibrated measurements. By identifying the maximum sample value, the precise location of the beginning of the Vsync 406 is identified (through the comparison of adjacent samples corresponding to the Vsync 406).

The first plurality of samples are examined to determine which portion of the initial data set 404 is an even or odd field. By sampling the specific characteristic data 157, of FIG. 1, for a period of time known to exceed two frame times (in excess of 66.67 mSec), it is ensured that sufficient information will be obtained for two entire frames.

There are many ways to distinguish an even field from an odd field based on the known characteristics of a composite video signal. For example, in an odd field, an arbitrary sample that is offset from the beginning of the Vsync 406 by a time interval equal to 6*H (where H is the horizontal line time interval 63.5 μSec.) occurs at a horizontal sync pulse (Hsync) 408 which starts line 10. On the other hand, in an even field, the same arbitrary sample falls in the middle of line 9. Consequently, the level at the arbitrary sample (measured from the Vsync 406 which is identified as explained above), is greater for an odd field than for an even field. Therefore, an even field is distinguished from an odd field by comparing the level of two occurrences of the arbitrary sample (obtained with respect to two occurrences of the Vsync 406 in a data set) from the plurality of samples.

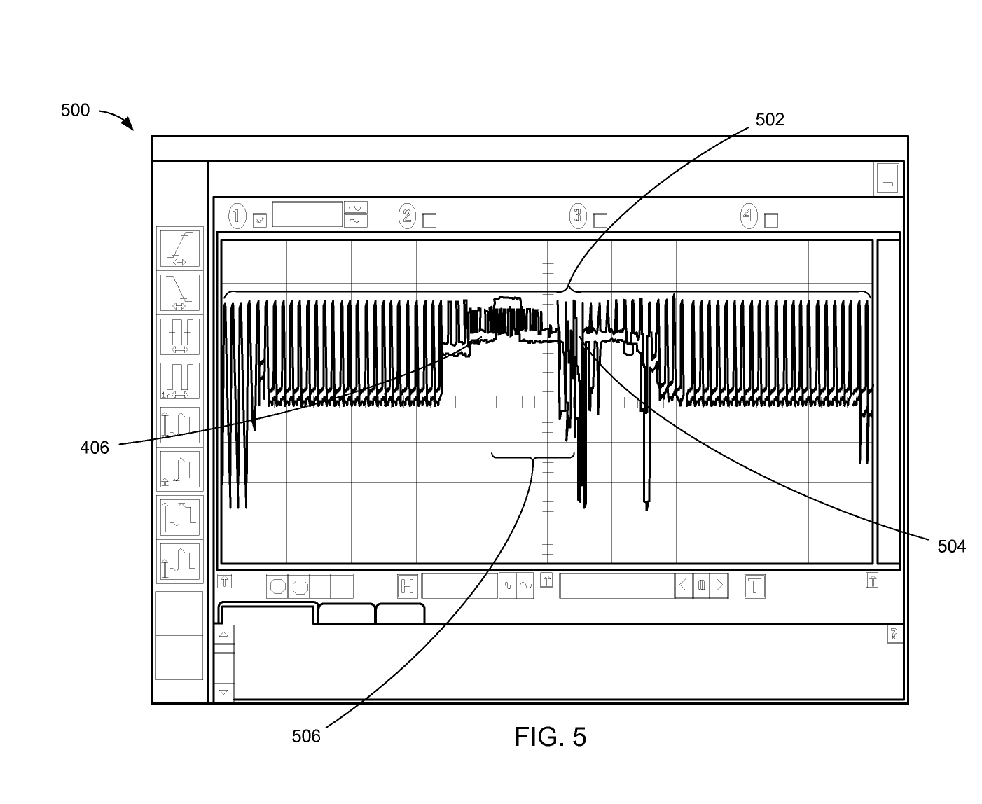

Referring now to FIG. 5, therein is shown a screen capture 500 of a magnified view of the data traced by the communication signal characteristic measurement system 100. The screen capture 500 depicts a data set 502 such as the data set 502 obtained when the communication signal characteristic measurement system 100 was tuned to a CSO distortion frequency with respect to the visual carrier frequency.

A quiet line 504 is actually line 12 of the composite video signal. An eight line delay 506 may identify the beginning of the quite line 504, approximately 508 mSec after the Vsync 406, corresponding to the quiet line 504 (line 12) to make CSO distortion measurements. According to CATV industry standards, during line 12 in both an even field and an odd field, video modulation is turned off, so that the only signal present during this time is a signal representing the level of the composite second order (CSO) distortion, or the “CSO signal”. The samples corresponding to line 12 are averaged in order to derive the power level of the communication signal without modulation. This is done at each of the CSO frequencies in order to determine the power level without modulation for each CSO frequency.

In the NTSC specification, the Vertical Synchronization Pulse (Vsync) 406 is defines as allocation line 4 (part of the display protocol that doesn't show up on screen). Allocation line 12 is defined as the quiet line 504, meaning there is no modulation signal allowed during the 63.5 micro seconds of that line. Line 12 is commonly used to evaluate distortion in the communication signal. By specification the quiet line 504 is always 8 lines (8×63.5 uS=508 mS) after the vertical synchronization pulse 406.

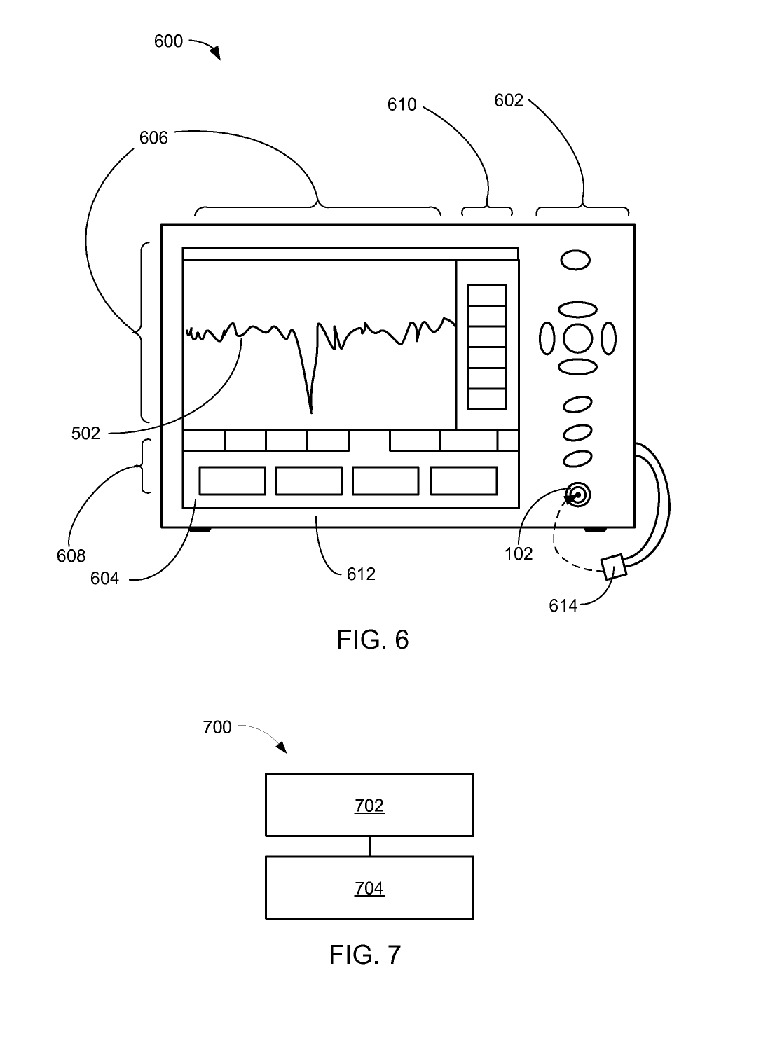

Referring now to FIG. 6, therein is shown a diagram of a channel tester 600 having the communication signal characteristic measurement system 100 in an embodiment of the present invention. The diagram of the channel tester 600 depicts hard keys 602, such as the power key, arrow keys, and function select keys, a touch screen 604 having a data display window 606, function soft keys 608, marker soft keys 610, the data set 502, the CATV input 102, and a tester chassis 612. A CATV source 614, such as a coaxial cable, may be coupled to the CATV input 102 for measuring the communication signal characteristics of the CATV source 614.

The implementation of the channel tester 600 is by way of an example only and the actual implementation may be different. Certain elements of the example may not be present on the actual implementation of the channel tester 600 or may be located differently.

Referring now to FIG. 7, therein is shown a flow chart of a communication signal characteristic measurement system 700 for facilitating the communication signal characteristic measurement system 100, in an embodiment of the present invention. The system 700 includes detecting a quiet line including: storing a specific characteristic data, detecting a vertical synchronization pulse in the specific characteristic data, and applying an eight line delay in the specific characteristic data in a block 702; and displaying a data set showing the quiet line relative to the vertical synchronization pulse in a block 704.

It has been discovered that the present invention thus has numerous aspects.

A principle aspect that has been unexpectedly discovered is that the present invention may detect at least an odd quiet line or an even quiet line without requiring an external synchronizer to locate the quiet line.

Another aspect of the present invention is that it valuably supports and services the historical trend of reducing costs, simplifying systems, and increasing performance.

These and other valuable aspects of the present invention consequently further the state of the technology to at least the next level.

Thus, it has been discovered that the communication signal characteristic measurement system of the present invention furnishes important and heretofore unknown and unavailable solutions, capabilities, and functional aspects for verifying the characteristics of a CATV distribution network. The resulting processes and configurations are straightforward, cost-effective, uncomplicated, highly versatile and effective, can be surprisingly and unobviously implemented by adapting known technologies, and are thus readily suited for efficiently and economically manufacturing CATV channel tester devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A communication signal characteristic measurement system comprising:
detecting a quiet line including:
storing a specific characteristic data,
detecting a vertical synchronization pulse in the specific characteristic data, and
applying an eight line delay in the specific characteristic data; and
displaying a data set showing the quiet line relative to the vertical synchronization pulse.

2. The system as claimed in claim 1 further comprising providing a processor for displaying the data set including:
reading an analog to digital convertor for reading the data set;
writing a memory with the data set from the analog to digital convertor; and
transferring to a user interface while reading the data set from the memory.

3. The system as claimed in claim 1 further comprising providing a logarithmic amplifier for sourcing the specific characteristic data.

4. The system as claimed in claim 1 further comprising programming an input output port expander for conditioning the specific characteristic data.

5. The system as claimed in claim 1 further comprising providing a channel tester for detecting the quiet line including:
providing a CATV input on the channel tester;
coupling a CATV source to the CATV input;
selecting a function soft key for entering a trace parameter in the channel tester; and
executing a sample and store block in the channel tester.

6. A communication signal characteristic measurement system comprising:
detecting a quiet line including:
storing a specific characteristic data includes storing two frames of the specific characteristic data,
detecting a vertical synchronization pulse in the specific characteristic data including finding a highest voltage in a single frame of a data set, and
applying an eight line delay in the specific characteristic data by sampling 508 μSec after the vertical synchronization pulse; and
displaying the data set showing the quiet line relative to the vertical synchronization pulse including writing a data display window.

7. The system as claimed in claim 6 further comprising providing a processor for displaying the data set including:
reading an analog to digital convertor for reading the data set;
writing a memory with the data set from the analog to digital convertor including setting a pointer for starting and stopping the memory transfer; and
transferring to a user interface while reading the data set from the memory including displaying on a display window the data set.

8. The system as claimed in claim 6 further comprising providing a logarithmic amplifier for sourcing the specific characteristic data including rapidly switching a frequency in the range of 10 μSec to 60 μSec.

9. The system as claimed in claim 6 further comprising programming an input output port expander for conditioning the specific characteristic data including activating a first switch, a second switch, a third switch, a programmable attenuator, a first digital to analog convertor, a second digital to analog convertor, a first programmable local oscillator, a second programmable local oscillator, or a combination thereof.

10. The system as claimed in claim 6 further comprising providing a calibrator circuit to establish a reference for comparing the specific characteristic data.

11. A communication signal characteristic measurement system comprising:
a quiet line detected including:
a specific characteristic data stored,
a vertical synchronization pulse detected in the specific characteristic data, and
an eight line delay in the specific characteristic data; and
a data set displayed for showing the quiet line relative to the vertical synchronization pulse.

12. The system as claimed in claim 11 further comprising a processor for displaying the data set including:
an analog to digital convertor for reading the data set;
a memory with the data set from the analog to digital convertor; and
a user interface for transferring the data set from the memory.

13. The system as claimed in claim 11 further comprising a logarithmic amplifier drives the specific characteristic data.

14. The system as claimed in claim 11 further comprising an input output port expander programmed for conditioning the specific characteristic data.

15. The system as claimed in claim 11 further comprising a channel tester for detecting the quiet line including:
a CATV input on the channel tester;
a CATV source coupled to the CATV input;
a function soft key for entering a trace parameter in the channel tester; and
a sample and store block executed in the channel tester.

16. The system as claimed in claim 11 further comprising:
storing two frames of the specific characteristic data;
a highest voltage detected in a single frame of the data set;
a 508 μSec delay after the vertical synchronization pulse; and
a data display window for displaying the data set.

17. The system as claimed in claim 16 further comprising a processor for displaying the data set including:
an analog to digital convertor for reading the data set;
a memory with the data set written from the analog to digital convertor includes a pointer set to start and stop the memory transfer; and
a user interface transferred while the data set is read from the memory includes a display window for displaying the data set.

18. The system as claimed in claim 16 further comprising a logarithmic amplifier sources the specific characteristic data includes a frequency change in the range of 10 μSec to 60 μSec.

19. The system as claimed in claim 16 further comprising an input output port expander to condition the specific characteristic data includes a first switch, a second switch, a third switch, a programmable attenuator, a first digital to analog convertor, a second digital to analog convertor, a first programmable local oscillator, a second programmable local oscillator, or a combination thereof activated.

20. The system as claimed in claim 16 further comprising a calibrator circuit establishes a reference to compare the specific characteristic data.
